(19) United States
(12) Patent Application Publication
(10) Pub. No.: US 2024/0189877 A1
(43) Pub. Date: Jun. 13, 2024

(54) PROCESSES FOR REMOVING PERFLUOROALKYL SUBSTANCES AND REGENERATING AN ADSORBENT USED WITH SAME

(71) Applicant: UOP LLC, Des Plaines, IL (US)

(72) Inventors: Aziz Sattar, Itasca, IL (US); Elizabeth Jensen, Des Plaines, IL (US); Erick J. Bennett, III, New Lenox, IL (US); Evgeny T. Kolev, Arlington Heights, IL (US); William J. Whyman, Collinsville, OK (US); Aric G. Fisher, Tulsa, OK (US); Ninart Narthasilpa, Chicago, IL (US); Robert Sanger, Mount Prospect, IL (US); Amanda J. Hickman, Evanston, IL (US); Erin M. Broderick, Arlington Heights, IL (US); Susan C. Koster, Carpentersville, IL (US); Benjamin D. Yuhas, Evanston, IL (US); Gregory B. Kuzmanich, Arlington Heights, IL (US)

(21) Appl. No.: 18/532,146

(22) Filed: Dec. 7, 2023

Related U.S. Application Data
(63) Continuation-in-part of application No. 18/064,025, filed on Dec. 9, 2022.

(51) Int. Cl. B09B 3/70; B01J 20/04; B01J 20/34; B09B 101/75

(52) U.S. Cl. CPC B09B 3/70; B01J 20/04; B01J 20/3433; B01J 2208/00628; B09B 2101/75

(57) ABSTRACT

Processes and apparatuses for converting PFAS. PFAS are heated and introduced to a reactant which will convert the PFAS. The PFAS may be in a stream that is a PFAS enriched stream formed by desorbing the PFAS from an adsorbent which removed the PFAS from a contaminant stream. An effluent from the PFAS conversion reaction is treated in a treatment zone and a treated effluent may be released to the atmosphere.

### RELATED APPLICATIONS

This application is a continuation-in-part of U.S. patent application Ser. No. 18/064,025, filed on Dec. 9, 2022.

### FIELD OF THE INVENTION

This invention relates generally to processes and apparatuses for converting and/or degrading poly- and perfluoroalkyl substances and more particularly to processes and apparatus for converting poly- and perfluoroalkyl substances and treating an effluent from the conversion.

### BACKGROUND OF THE INVENTION

Poly- and perfluoroalkyl substances (“PFAS”) are “forever chemicals” that are very stable and persist in the environment. These forever chemicals are linked to harmful effects on the kidney, liver, blood, and immune system. Examples of such chemicals are surfactants in industrial and consumer products, such as firefighting foams, alkaline cleaners, paints, non-stick cookware, carpets, upholstery, shampoos, floor polishes, fume suppressants, semiconductors, photographic films, pesticide formulations, food packing, masking tape, and denture cleaners.

The EPA has a list of over 179 PFAS that are known or believed to be toxic and it is believed that this list will grow as there are more than 12,000 different PFAS. Currently, the EPA advises a maximum limit of <70 ppt of PFAS, however stricter EPA regulations and limits have been proposed.

Given the health risks associated with PFAS and their environmental impact, there is an ongoing need for processes and apparatuses which effectively and efficiently remove and convert PFAS.

### SUMMARY OF THE INVENTION

The present invention provides for the conversion of PFAS. The PFAS heated and then convert with a reactant to form fluoride compounds which will minimize emission of light fluorinated hydrocarbons (which have extremely high global warming potentials compared to carbon dioxide). An effluent, or portions thereof is treated in a treatment zone which may include a dry sorbent injection zone, a wet scrubber zone, a carbon bed, and/or an ion exchange zone.

Therefore, the present invention may be characterized, in at least one aspect, as providing a process for converting poly- and perfluoroalkyl substances (PFAS) by: heating PFAS to provide a heated PFAS; introducing the heated PFAS to a vessel containing a reactant and being operated under conditions to convert the PFAS and provide an effluent, the effluent comprising a fluoride species, and wherein the reactant is selected from a group consisting of: a base of calcium, sodium, potassium, lithium, magnesium, aluminum, silicon, and combinations thereof; and treating the effluent in a treatment zone to provide a treated effluent, wherein the treatment zone comprises at least one of: a dry sorbent injection zone; a wet scrubber zone; a carbon bed; an ion exchange zone; or any combination thereof.

The process may further include cooling, in a thermal reduction zone, the effluent before treating the effluent in the treatment zone.

The treatment zone may include the dry sorbent injection zone and the process may further include mixing an adsorbent with the effluent to provide the treated effluent, and the adsorbent may include sodium, calcium, potassium, magnesium, aluminum, silicon or any combination thereof in a solution or mixture. The adsorbent may include a mixture of a fresh adsorbent and a recycled adsorbent. The process may further include quenching the treated effluent. The dry sorbent injection zone may include a filtration zone configured to separate the treated effluent and provide a residue and a vent gas. The process may include recycling the residue to the dry sorbent injection zone.

The treatment zone may include the wet scrubber zone, and the process may further include mixing an aqueous caustic stream with the effluent to provide the treated effluent. The aqueous caustic stream may include sodium, calcium, potassium, magnesium, or any combination thereof. The process may further include separating the treated effluent into a liquid and a vent gas. The liquid may include particulates. The treatment zone may include the carbon bed, the ion exchange zone, or both, and the process may include passing the liquid to the carbon bed or the ion exchange zone. The treatment zone may include the carbon bed, and the process may include passing the vent gas to the carbon bed.

The treatment zone may include the carbon bed, the ion exchange zone, or both, and may also include a sensor configured to provide a measurement. The carbon bed or the ion exchange zone may receive a liquid portion of the effluent. The process may also include determining a fluorine concentration in the liquid portion of the effluent from the measurement. The process may further include monitoring the fluorine concentration in the liquid portion of the effluent. The process may also include adjusting a process condition when the fluorine concentration is outside of a predetermined range.

The heated PFAS may have a temperature between 400° C. to 925° C. when introduced into the vessel.

The PFAS may be heated in an absence of the reactant.

The treatment zone may provide a liquid stream, and the process may also include recycling the liquid stream to the vessel.

The treatment zone may provide a liquid stream, the process may also include quenching the effluent with the liquid stream.

The present invention may also be generally characterized as providing an apparatus for converting poly- and perfluoroalkyl substances (PFAS) having: a heater configured to heat a stream comprising PFAS to a temperature between 400° C. to 925° C. to provide a heated PFAS; a vessel including a reactant and configured to receive the heated PFAS and provide an effluent, wherein the reactant is configured to convert the PFAS into a fluoride of calcium, sodium, potassium, lithium, magnesium, aluminum, silicon, wherein the reactant is selected from a group consisting of: a base of calcium, sodium, potassium, lithium, magnesium, aluminum, silicon, and combinations thereof; and, a treatment zone configured to receive the effluent and provide a treated effluent. The treatment zone includes at least one of: a dry sorbent injection zone; a wet scrubber zone; a carbon bed; an ion exchange zone; or any combination thereof.

The apparatus may further include a sensor configured to provide a measurement relating to the effluent, the treated effluent, or portions thereof and the measurement may relate to a fluorine concentration in the effluent, the treated effluent, or portions thereof.

The apparatus may further include a thermal reduction zone disposed between the vessel and the treatment zone.

Additional aspects, embodiments, and details of the invention, all of which may be combinable in any manner, are set forth in the following detailed description of the invention.

### DETAILED DESCRIPTION OF THE DRAWINGS

One or more exemplary embodiments of the present invention will be described below in conjunction with the following drawing figures, in which:

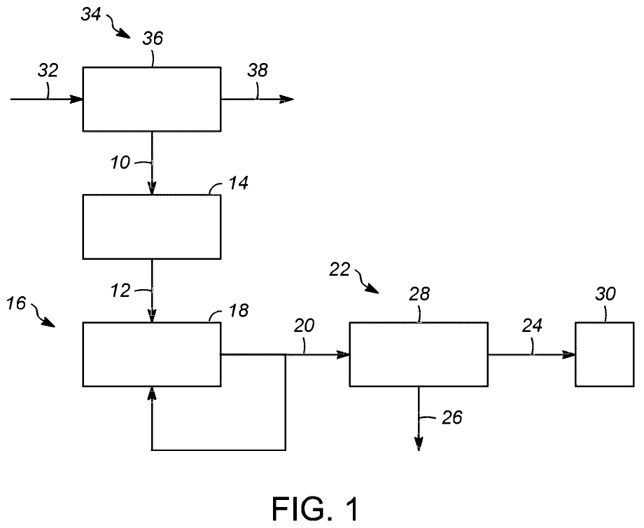

FIG. 1 is a process flow diagram according to one or more aspects of the present invention;

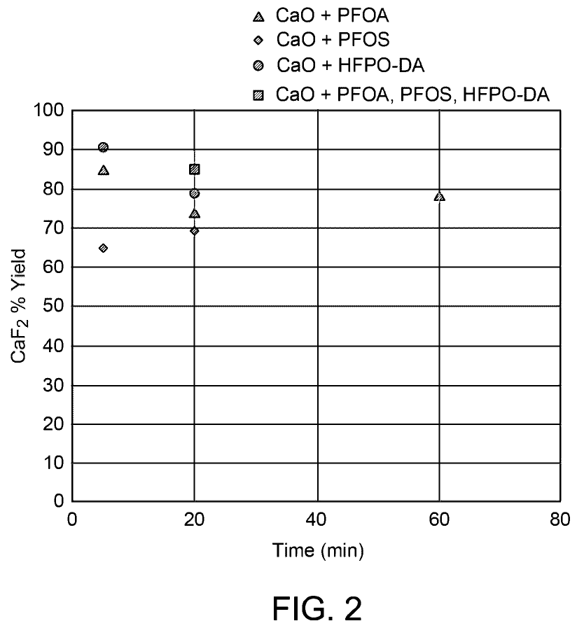

FIG. 2 is a graph showing experimental data comparing calcium fluoride yield vs. reaction time;

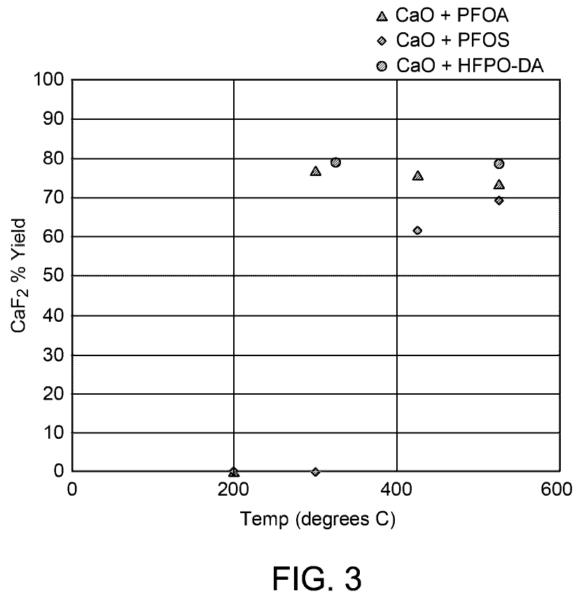

FIG. 3 is a graph showing experimental data comparing calcium fluoride yield vs. reaction temperature;

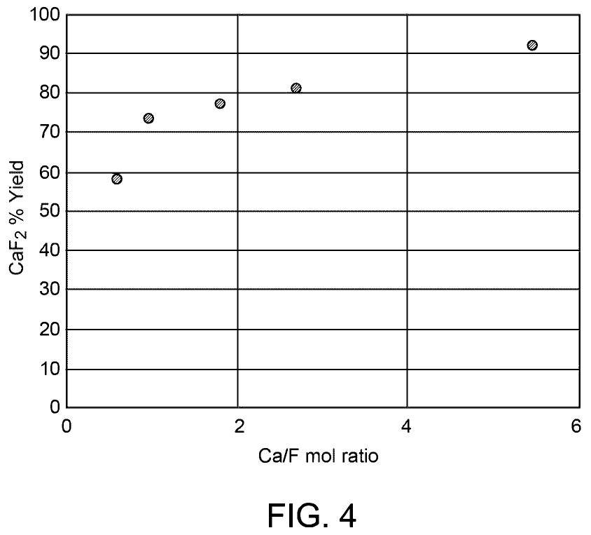

FIG. 4 is a graph showing experimental data comparing calcium fluoride yield vs. calcium to fluoride ratio;

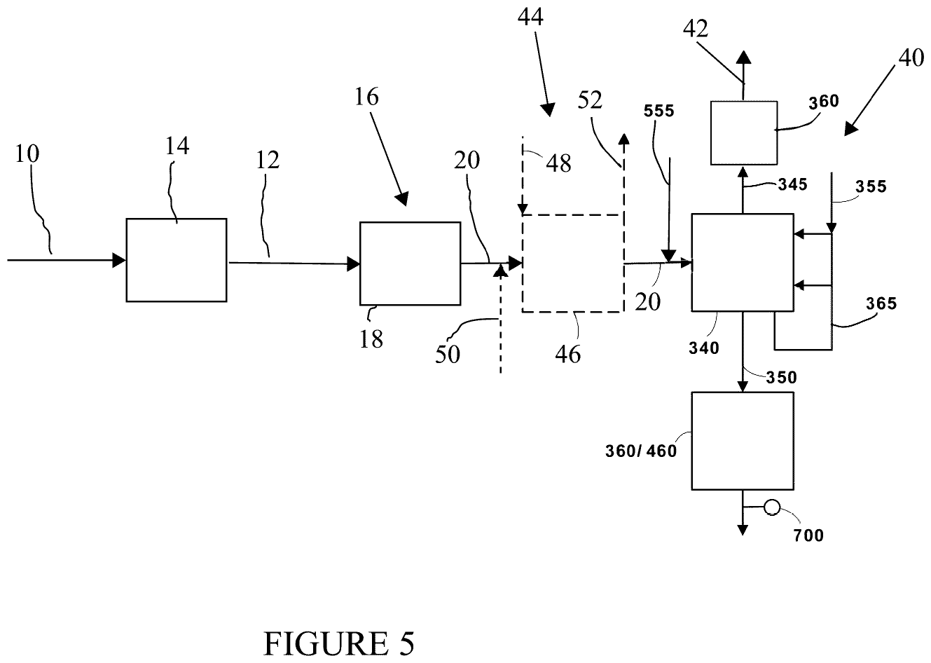

FIG. 5 shows a process flow diagram according to one or more aspects of the present invention;

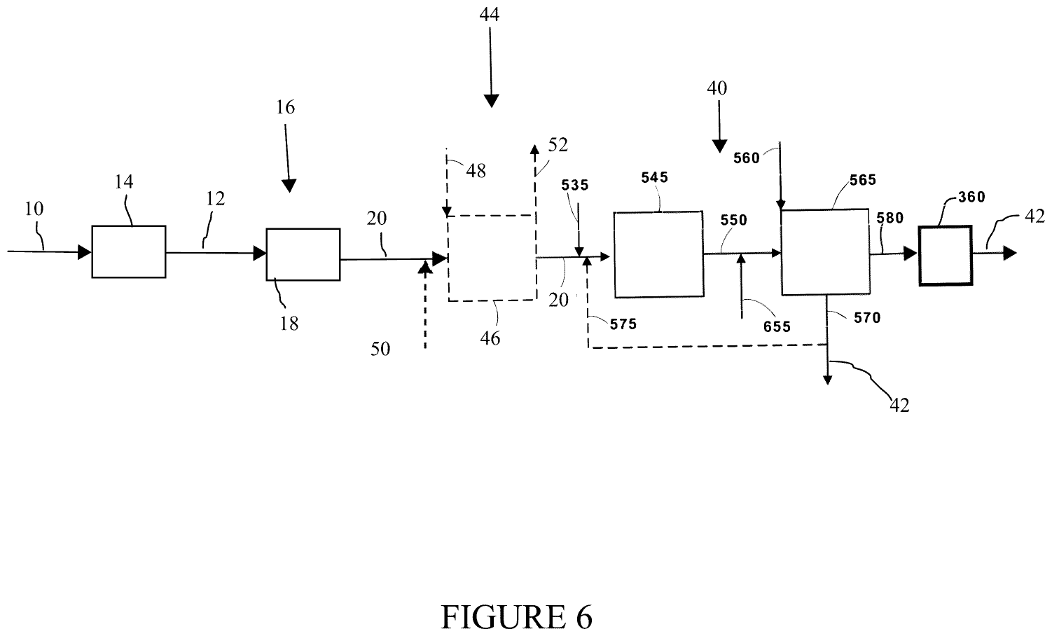

FIG. 6 shows a process flow diagram according to one or more aspects of the present invention; and,

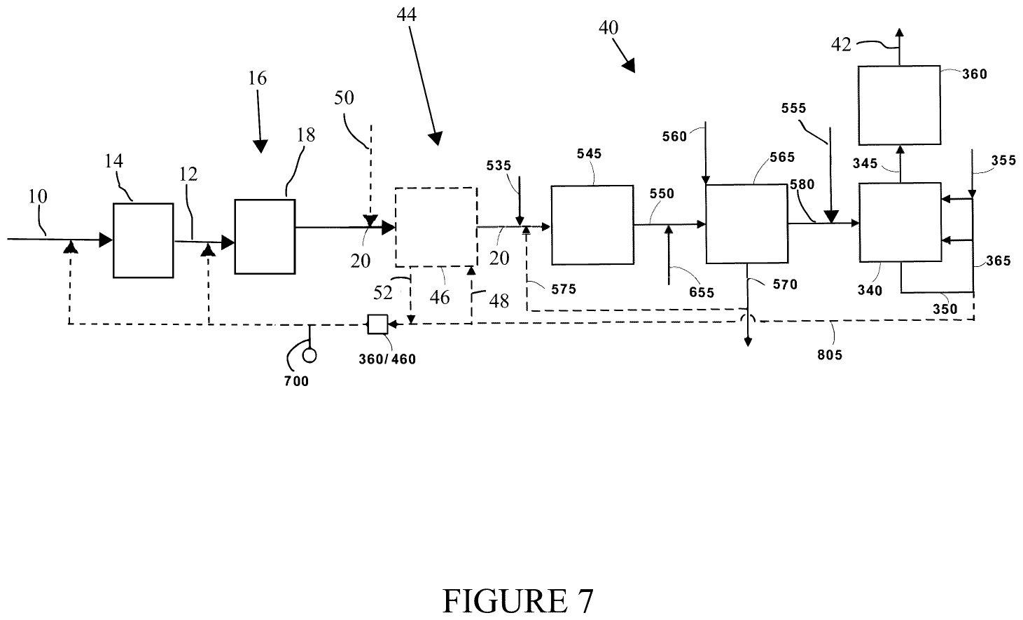

FIG. 7 shows a process flow diagram according to one or more aspects of the present invention.

### DETAILED DESCRIPTION OF THE INVENTION

As mentioned above, the present invention addresses PFAS removal as well as the regeneration of adsorbent used to remove PFAS from contaminated streams. In general, PFAS are heated and then introduced to a reactant which will convert the PFAS into and provide an effluent comprising a fluoride species. By heating the PFAS first and then introducing the heated PFAS, the process is believed to be more energy efficient. Additionally, the interaction between solid reactant and gas may lead to further efficiencies for the process. The present invention is further directed at the treatment of the effluent before a treated effluent is vented or otherwise released to the atmosphere/environment.

As used herein, “PFAS” means fluorine containing compounds, including, poly- and perflouroalky substances, that include at least one fully fluoridated methyl or methylene carbon atom. Commonly made, used, and found compounds include perfluorooctanoic acid (PFOA), perfluorooctanesulfonic acid (PFOS), perfluorobutane sulfonic acid (PFBS), perfluoropentanesulfonic acid (PFPS), perfluorohexane sulfonic acid (PFHxS), perfluoroheptanesulfonic acid (PFHpS), perfluorononanesulfonic acid (PFNS), or perfluorodecanesulfonic acid (PFDS), hexafluoropropylene oxide dimer acid (HFPO-DA). This list is not intended to be exhaustive, but merely exemplary. Additional PFAS compounds, can be found, for example in the definitions provided by the EPA. Additionally, it should be understood that “PFAS” also refers to the intermediate compounds produced during the conversion of an original PFAS compound.

As used herein, the term “substantially” can mean an amount generally of at least 90%, preferably 95%, and optimally 99%, by weight, of a compound or class of compounds in a stream.

As depicted, process flow lines in the figures can be referred to interchangeably as, e.g., lines, pipes, feeds, effluents, products, or streams.

As used herein, the term “zone” can refer to an area including one or more equipment items and/or one or more sub-zones. Equipment items can include one or more reactors or reactor vessels, heaters, exchangers, pipes, pumps, compressors, and controllers. Additionally, an equipment item, such as a reactor, dryer, or vessel, can further include one or more zones or sub-zones.

With these general principles in mind, one or more embodiments of the present invention will be described with the understanding that the following description is not intended to be limiting.

As shown in FIG. 1, in various aspects of the present invention, a stream of PFAS 10 is heated to provide a heated PFAS stream 12. The stream of PFAS 10 is heated in, for example, a heater 14. In a stream of PFAS, the PFAS are heated in the absence of a reactant which may be a base containing calcium, sodium, potassium, magnesium, lithium, and/or aluminum. For example, the PFAS stream 10 may be heated before being passed to a reaction zone 16 having a reaction vessel, or reactor, 18. The PFAS 10 may be heated to a temperature so that when the heated PFAS contact or are introduced to the reactant, the PFAS have a temperature between 400° C. to 925° C., or between 525° C. to 825° C. Without being bound by theory, it is believed that the PFAS may partially degrade during the initial heating prior to entering the reactor. These partially degraded molecules may have increased reactivity in the reactor.

The heated PFAS stream 12 may be introduced into the vessel 18 which contains the reactant, as either a fixed bed or a powder or particulate stream. The reactant is configured to convert the PFAS into a fluoride of calcium, sodium, potassium, lithium, magnesium, silicon, and/or aluminum. Accordingly, the reactant may contain a base of calcium, sodium, potassium, lithium, magnesium, aluminum, and combinations thereof, such as salts, oxides, hydroxides, carbonates, silicates, citrates, phosphates.

For example, the reactant may be a calcium base. In the presence of the calcium base, the PFAS are converted into calcium fluoride, carbon dioxide, and water. The calcium base may include calcium hydroxide, calcium oxide, calcium carbonate, calcium silicate or combinations thereof. In some embodiments, the calcium base consists of calcium oxide. A molar ratio of calcium to fluoride in the vessel 18 may be between 0.5 to 10, or between 0.5 to 2. The PFAS may have a residence time in the vessel 18 and/or in the presence of the calcium base for a time between 0.5 seconds to 10 minutes.

An effluent 20 from the vessel 18 comprises a fluoride species, in particular one or more fluorides of calcium, sodium, potassium, lithium, magnesium, silicon, and/or aluminum. The effluent 20 may also contain other conversion reaction products such as carbon dioxide, carbon monoxide, and/or water. Accordingly, in the embodiment of FIG. 1, the effluent 20 may be separated, in a separation zone 22, into a stream comprising carbon dioxide and water 24 and solid calcium fluoride 26. A centrifuge 28 may be used in the separation zone 22, however, other separation devices may be used such as, for example, a bag house. Additionally, carbon dioxide may be removed in a carbon dioxide scrubber 30. A portion of the effluent 20 may be passed back to the vessel 18 to minimize non-converted PFAS from being released.

The PFAS stream 10 may be a PFAS enriched stream generated by removing PFAS from a contaminated stream 32. In the present application, “a PFAS enriched stream” means that at least 0.1% of the stream comprises PFAS.

For example, the contaminated stream 32 may be passed to a purification zone 34 containing a vessel 36 which contains an adsorbent configured to selectively retain PFAS and provide a treated stream 38. The adsorbent may be granular activated carbon, an ion exchange resin, or an aluminosilicate. For example, the adsorbent may be a microporous aluminosilicate with an atomic ratio of silicon to aluminum greater than 50, or greater than 100. The adsorbent may be a mesoporous aluminosilicate with an atomic ratio of silicon to aluminum greater than 50, or greater than 100. The adsorbent may be a microporous silicate or a mesoporous silicate that is essentially free of aluminum. Although depicted with only one vessel 36, it is contemplated that more than one vessel 36 containing the adsorbent is provided. The adsorbent in the multiple vessels 36 may be regenerated at different times.

The PFAS may be desorbed from the adsorbent to provide the PFAS enriched stream. Depending on the adsorbent, the PFAS may be desorbed with a solvent or with heat. In some embodiments, this may be a batch process. In some embodiments, this may be a continuous process. For example, a liquid phase desorbent such as water, methanol, or hydrocarbons could be used to desorb the PFAS and produce an effluent stream enriched in PFAS. The liquid desorbent could be separated from the PFAS prior to the thermal treatment or the entire effluent could be sent to the reactor.

Alternatively, the PFAS may be concentrated by being adsorbed on the adsorbent, and then the adsorbent, with the PFAS, may be mixed with calcium base.

Therefore, an apparatus for conversion of PFAS may include a first vessel 36 which receives the contaminated stream 32 which includes PFAS. The first vessel 36 includes an adsorbent configured to selectively retain the PFAS. Under suitable conditions, the adsorbent may desorb the PFAS and provide the PFAS stream 10. A second vessel 18 includes the reactant which converts the PFAS into a fluoride species. A heater 14 is provided to heat the PFAS stream 10 in the absence of the reactant.

In an embodiment, instead of desorbing the PFAS into a PFAS stream, the present invention contemplates a mixture of adsorbent containing PFAS being heated in the presence of the reactant. The heat will desorb the PFAS from the adsorbent and thus regenerate the adsorbent.

Turning to FIGS. 5 to 7, in order to remove any unwanted or harmful components of the effluent 20 a treatment zone 40 may be utilized. The same reference numbers are utilized in FIGS. 5 to 7 to refer to the same features as FIG. 1. The treatment zone 40 may contain one or more treaters. As will be described in more detail below, the treaters may have a dry sorbent injection zone, a wet scrubber zone, a carbon bed, and/or an ion exchange zone. After passing through the one or more treaters of the treatment zone 40, a treated effluent 42 may be released to the atmosphere.

However, starting with FIG. 5, prior to the treatment zone 40, the effluent 20 may be cooled in a thermal reduction zone 44, or cooling zone, so that a temperature of the effluent 20 is reduced, preferably by at least 5%. The thermal reduction zone 44 may include a heat exchanger 46 configured to transfer heat from the effluent 20 to a heat exchange fluid 48. The heat exchanger 46 could be located within the reactor 18 or it could be located externally. The heat exchange fluid 48 may be boiler feed water, or combustion air, or oil feedstock, which forms a heated stream 52. If the heated stream 52 is boiler feed water, it can be sent to a Heat Recovery Steam Generator (HRSG) saturated stream unit. If the heated stream 52 is oil feed stock, it can be sent to the hot oil system of a main process unit. Alternately, or additionally, all or a portion the heated stream 52 can be sent to other areas of the plant as needed.

Additionally, or alternatively, the thermal reduction zone 44 may receive a quench fluid 50 that is mixed with the effluent 20. The quench fluid 50 may be water, air, a combination thereof, or even a portion of a stream provided by the treatment zone 40.

In some embodiments, a sensor (not shown) or other monitoring device may be utilized to measure a temperature of the effluent 20 at various points (i.e., upstream of the thermal reduction zone 44 and/or downstream of the thermal reduction zone 44). The obtained or measured temperature may be compared to a predetermined temperature or other set point a flow of a cooling fluid (i.e., the heat exchange fluid 48 and/or the quench fluid 50) may be adjusted in response to the comparison to raise or lower the temperature of the effluent 20.

With or without thermal reduction, the effluent 20 is passed to the treatment zone 40 to reduce and/or remove any unwanted or harmful compounds. In FIG. 5, the treatment zone 40 which includes a wet scrubber zone 340 for removing an anionic fluoride species contaminant from the effluent 30. The wet scrubber zone 340 will reduce the chances of release of light fluorinated carbon and hydrofluorocarbons or other components from the oxidation of the PFAS. Additionally, the wet scrubber zone 340 will neutralize hydrogen fluoride that is produced.

The effluent 20 is passed to the wet scrubber zone 340 to minimize emission of light fluorinated hydrocarbons and the temperature of the effluent 20 is reduced to a saturation temperature using an aqueous stream 555. An aqueous caustic stream 355 may be introduced to the wet scrubbing zone 340 near a top of a column, so that the caustic stream flows downwards and contacts the effluent 20, which is cooled, and flowing upward.

The inlet temperature for the wet scrubber zone 340 is typically in the range of 45° C. to 150° C. with a pressure of −12 kPa(g) to 50 kPa(g). The outlet temperature for the wet scrubber zone 340 is typically in the range of 45° C.-75° C. with a pressure of −15 kPa(g) to 50 kPa(g). The operating parameters of the wet scrubber zone 340 are merely contemplated or exemplary values and are not intended to be limiting.

The aqueous caustic stream 355 may include compounds having sodium, calcium, potassium, magnesium, or any combination thereof such as NaHCO₃, NaOH, KOH, K₂CO₃, CaOH, NaHCO₃·Na₂CO₃·2(H₂O), Na₂CO₃·2Na₂CO₃·3(H₂O), CaCO₃, Ca(HCO₃)₂, Ca(OH)₂, Mg(OH)₂, CaSO₄·2(H₂O), CaO, CaCO₃·MgCO₃. Reactions that take place in the wet scrubber zone 340 may lead to the formation and/or conversion of fluoride components including, but not limited to, H₂O, CaCl₂), CaF, CaF₂, CaCO₃, Na₂CO₃, NaCl, CO₂, Na₂NO₃, NaCl, NaF, K₂CO₃, KNO₃, KCl, KF, MgCl₂, MgCO₃, Mg(NO₃)₂, to name a few.

An effluent of the wet scrubber zone 340 may be separated into various streams. For example, a vent gas 345 from the wet scrubber zone 340 has a reduced level of fluoride species compared to the effluent 330. The vent gas 345 can be vented from a stack in the wet scrubber zone 340 to the atmosphere. One or more liquid streams 350, 365 can be generated which can be an aqueous stream 350 released to the environment or a recycle stream 365 which can be passed back into the wet scrubber zone 340. One of more of the liquid streams 350, 365 may be used as the quench stream 50 and or recycled back to the reactor 18.

It is contemplated that a carbon bed 360 and/or an ion exchange zone 460 are provided before the aqueous stream 350 or vent gas stream 345 is released. As is known, a carbon bed 360 includes material such as activated carbon, reticulated vitreous carbon foam, carbon aerogel, sheets of carbon paper, carbon fiber or carbon fiber containing composites, carbon fiber aerogel, graphene, graphene aerogel, graphene oxide media, additive printed carbon, additive printed graphene, graphitized media, ionized carbon/noncarbon and magnetized carbon/non-carbon media, and electrically charged carbon media. The material adsorbs various compounds like furans and dioxins.

Similarly, the ion exchange zone 460 contains a medium, typically a resin, that selectively removes ions from the stream. The material in the ion exchange zone 460 may be selected for PFAS and other fluorinated species. The material should be tolerant to NaCl and NaOH, as well as dissolved gases.

Additionally, a sensor 700 may be utilized to obtain a measurement that can be utilized to determine a fluorine concentration. For example, the sensor 700 could directly measure the fluorine concentration in the respective stream or vessel. Alternatively, the sensor 700 may measure some other attribute, condition, or parameter of the stream which could be utilized to determine a fluorine concentration, for example with a look-up table. The determined fluorine concentration may be monitored and utilized to ensure that the fluorine level is suitable for release of the respective stream(s). Thus, it should be appreciated, that the depicted location of the sensor 700 is merely exemplary and not limiting. Additionally, based on the fluorine concentration, a controller (not shown) may send signals to other equipment to adjust various processing conditions, like flow rate, temperature, etc., so as to impart a change in the process in an attempt to adjust the fluorine level of the respective stream. For example, a flow rate of an adsorbent or caustic solution may be adjusted.

Turning to FIG. 6, the treatment zone 40 may include a dry sorbent injection zone 545. Accordingly, the effluent 20 may be mixed with an adsorbent/sorbent that may include a fresh adsorbent 535 and a recycled adsorbent 575. Within the dry sorbent injection zone 545, the adsorbent reacts with various fluoride species and other conversion reactant products and/or PFAS, in effluent 20.

The adsorbent may include sodium, calcium, potassium, magnesium, or any combination thereof in a solution or mixture. For example, the adsorbent may include one or more of H₂O, CaCl₂), CaF, CaF₂, CaCO₃, Na₂CO₃, NaCl, CO₂, Na₂NO₃, NaCl, NaF, K₂CO₃, KNO₃, KCl, KF, MgCl₂, MgCO₃, Mg(NO₃)₂, NaHCO₃·Na₂CO₃·2(H₂O), Na₂CO₃·2Na₂CO₃·3(H₂O), CaCO₃, Ca(HCO₃)₂, Ca(OH)₂, Mg(OH)₂, CaO, CaCO₃·MgCO₃, (Ca(OH)₂·(Mg(OH)₂).

An inlet temperature for the dry sorbent injection zone 545 is typically in a range of 200° C. to 400° C. with a pressure of −3 kPa(g) to 50 kPa(g). An outlet temperature for the dry sorbent injection zone 545 is typically in the range of 150° C. to 400° C. with a pressure of −5 kPa(g) to 50 kPa(g). The operating parameters of the dry sorbent injection zone 545 are merely contemplated or exemplary values and are not intended to be limiting. Indeed, it is contemplated that the dry sorbent injection zone 545 is operated between 400° C. to 925° C., or between 525° C. to 825° C.

A treated effluent 550 has a reduced level of fluoride species compared to the effluent 20. The treated effluent 550 may be combined with a quench stream 655 including air, and/or water, and/or quenched flue gas and/or inert gas or any mixture thereof.

The treated effluent 550 may be passed to a filtration zone 565 for the removal of at least one of H₂O, CaCl₂), CaF, CaF₂, CaCO₃, Na₂CO₃, NaCl, CO₂, Na₂NO₃, NaCl, NaF, K₂CO₃, KNO₃, KCl, KF, MgCl₂, MgCO₃, Mg(NO₃)₂, organic acids and fine particulate matter. An inlet temperature for the filtration zone 565 is typically in a range of 150° C. to 350° C. with a pressure of −5 kPa(g) to 50 kPa(g). An outlet temperature for the filtration zone 565 is typically in a range of 150° C. to 350° C. with a pressure of −7 kPa(g) to 50 kPa(g). The operating parameters of the filtration zone 565 are merely contemplated or exemplary values and are not intended to be limiting.

The filtration zone 565 may include a bag filter, and/or ceramic filter, and/or an electrostatic precipitator (ESP) for separation of solid particles from a gaseous portion. An instrument air purge or high voltage DC 560 is introduced into the filtration zone 565. In the case of the instrument air purge, it purges the retained material from the filter. In the case of the high voltage stream, it charges the cathodes of the ESP. The particulate may be removed from the ESP by vibration. A residue stream 570 comprising of at least one H₂O, CaCl₂), CaF, CaF₂, CaCO₃, Na₂CO₃, NaCl, CO₂, Na₂NO₃, NaCl, NaF, K₂CO₃, KNO₃, KCl, KF, MgCl₂, MgCO₃, Mg(NO₃)₂, NaHCO₃·Na₂CO₃·2(H₂O), Na₂CO₃·2Na₂CO₃·3(H₂O), CaCO₃, Ca(HCO₃)₂, Ca(OH)₂, Mg(OH)₂, CaO, CaCO₃·MgCO₃, (Ca(OH)₂·(Mg(OH)₂), organic acids and fine particulate matter depending exits the filtration zone 565. All or a portion of the residue stream 570 may be utilized for the recycled adsorbent 575. A vent gas stream 580 may be passed to a carbon bed 360 and then vented to the atmosphere.

Turning to FIG. 7, the treatment zone 40 may include both the dry sorbent injection zone 545, the filtration zone 565, and the wet scrubber zone 340. Accordingly, as shown, the vent gas stream 580 is passed to the wet scrubber zone 340 and is processed as discussed above. The aqueous recycle streams 350, 805 may be passed back to the wet scrubber zone 340. Additionally, the aqueous recycle streams 350, 805 may be recycled to the vessel 18 for example by being mixed with the 10 or heater feed stream 12. Further, it is contemplated that the aqueous recycle stream 350, 805 is utilized as the heat exchange fluid 48 for the heat exchanger 46 before being passed to the reactor 18. The aqueous recycle streams 350, 805 may be utilized as the quench fluid 50.

Additionally, a carbon bed 360 may be utilized to remove dioxins and/or furans from the vent gas stream 345 from the wet scrubber zone 340. Finally, the aqueous recycled stream 350 may be passed to a carbon bed 360 and/or ion exchange zone 460. Again, a sensor 700 may be utilized to obtain a measurement that may be utilized to obtain a fluorine level in the aqueous recycled stream 805.

The systems and devices described herein may include a controller or a computing device comprising a processing and a memory which has stored therein computer-executable instructions for implementing the processes described herein. The processing unit may comprise any suitable devices configured to cause a series of steps to be performed so as to implement the method such that instructions, when executed by the computing device or other programmable apparatus, may cause the functions/acts/steps specified in the methods described herein to be executed. The processing unit may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory may be any suitable known or other machine-readable storage medium. The memory may comprise non-transitory computer readable storage medium such as, for example, but not limited to, an electronic, magnetic, optical, electromagnetic, infrared, or semiconductor system, apparatus, or device, or any suitable combination of the foregoing. The memory may include a suitable combination of any type of computer memory that is located either internally or externally to the device such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. The memory may comprise any storage means (e.g., devices) suitable for retrievably storing the computer-executable instructions executable by processing unit.

The methods and systems described herein may be implemented in a high-level procedural or object-oriented programming or scripting language, or a combination thereof to communicate with or assist in the operation of the controller or computing device. Alternatively, the methods and systems described herein may be implemented in assembly or machine language. The language may be a compiled or interpreted language. Program code for implementing the methods and systems described herein may be stored on the storage media or the device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein.

Computer-executable instructions may be in many forms, including modules, executed by one or more computers or other devices. Generally, modules include routines, programs, objects, components, data structures, etc., that perform particular tasks or implement particular abstract data types. Typically, the functionality of the modules may be combined or distributed as desired in various embodiments.

It will be appreciated that the systems and devices and components thereof may utilize communication through any of various network protocols such as TCP/IP, Ethernet, FTP, HTTP and the like, and/or through various wireless communication technologies such as GSM, CDMA, Wi-Fi, and WiMAX, is and the various computing devices described herein may be configured to communicate using any of these network protocols or technologies.

Any of the above lines, conduits, units, devices, vessels, surrounding environments, zones or similar may be equipped with one or more monitoring components including sensors, measurement devices, data capture devices or data transmission devices. Signals, process or status measurements, and data from monitoring components may be utilized to monitor conditions in, around, and on process equipment. Signals, measurements, and/or data generated or recorded by monitoring components may be collected, processed, and/or transmitted through one or more networks or connections that may be private or public, general or specific, direct or indirect, wired or wireless, encrypted or not encrypted, and/or combination(s) thereof; the specification is not intended to be limiting in this respect.

Signals, measurements, and/or data generated or recorded by monitoring components may be transmitted to one or more computing devices or systems. Computing devices or systems may include at least one processor and memory storing computer-readable instructions that, when executed by the at least one processor, cause the one or more computing devices to perform a process that may include one or more steps.

For example, the one or more computing devices may be configured to receive, from one or more monitoring component, data related to at least one piece of equipment associated with the process. The one or more computing devices or systems may be configured to analyze the data. Based on analyzing the data, the one or more computing devices or systems may be configured to determine one or more recommended adjustments to one or more parameters of one or more processes described herein. The one or more computing devices or systems may be configured to transmit encrypted or unencrypted data that includes the one or more recommended adjustments to the one or more parameters of the one or more processes described herein.

It should be appreciated and understood by those of ordinary skill in the art that various other components such as valves, pumps, filters, coolers, etc. were not shown in the drawings as it is believed that the specifics of same are well within the knowledge of those of ordinary skill in the art and a description of same is not necessary for practicing or understanding the embodiments of the present invention.

### Experiments

PFOA (0.15 g) was dissolved in water (15 g), and UZM-50 (0.98 g) was added. UZM-50 was prepared according to the methods set forth in U.S. Pat. No. 10,632,454. The mixture was stirred for 1 day at room temperature. The solid was separated from the liquid through centrifugation. The UZM-50 was combined with water and centrifuged to rinse any non-adsorbed PFAS away. The PFOA loaded UZM-50 was dried at 80° C. on a rotovap rotary evaporator. The PFOA loaded UZM-50 (1.0 g) was combined with calcium oxide (1.42 g) and ground with a mortar and pestle. The solid mixture was then slowly poured into a glass reactor and. heated in a furnace at 525° C. for 20 min. After cooling, the solid was analyzed by XRD. XRD indicated the formation of calcium fluoride. It is believed that similar results will be shown when the PFAS are desorbed and heated and then introduced to the calcium base.

### Temperature, Ca/F Ratio, and Time for Degradation

Additionally, PFAS (PFOA, PFOS, or HFPO-DA) was mixed with a calcium base (0.6-5 mol Ca/F) with a mortar and pestle. The solid mixture was poured into a glass reactor and heated in a furnace between 200° C. and 525° C. for 5-60 min. The solid was cooled and submitted for XRD—which indicated the presence of calcium fluoride.

In FIG. 2, the depicted graph shows the relationship between the calcium fluoride yield and the reaction time between the PFAS and the calcium base. For the experiments of FIG. 2, a molar ratio of Ca/F was 1.3 and the PFAS had a temperature of 525° C.

In FIG. 3, the depicted graph shows the relationship between the calcium fluoride yield and the temperature of the PFAS when exposed to the calcium base. For the experiments of FIG. 3, a molar ratio of Ca/F was 1.3 and the PFAS were exposed to the calcium base for 20 minutes.

In FIG. 4, the depicted graph shows the relationship between the calcium fluoride yield and the molar ratio of Ca/F. For the experiments of FIG. 3, the PFAS had a temperature of 525° C. and the PFAS were exposed to the calcium base for 20 minutes.

As can be seen from FIGS. 2 to 4, the PFAS were successfully degraded with varying conditions.

Desorption of PFAS from GAC and Treatment with Calcium Oxide

GAC was shook with PFOA (2.18 g) in water (200 mL) at room temperature for 3 h. The GAC mixture was filtered to isolate the PFOA loaded GAC. The GAC was washed with water and dried on a rotovap to remove excess water. The GAC (10 g) was loaded into the top heating zone of a quartz reactor with nitrogen flow (150 cc/min). The lower heating zone of the reactor was loaded with 2 beds of calcium oxide (2.3 g each). The top heating zone reached 325° C., and the bottom heating zone reached 425° C. After heating for 1 h, the reactor was cooled. The CaO beds were submitted for XRD, and CaF₂ was detected.

### Specific Embodiments

While the following is described in conjunction with specific embodiments, it will be understood that this description is intended to illustrate and not limit the scope of the preceding description and the appended claims.

A first embodiment of the invention is a process for converting poly- and perfluoroalkyl substances (PFAS), the process comprising heating PFAS to provide a heated PFAS; introducing the heated PFAS to a vessel containing a reactant and being operated under conditions to convert the PFAS and provide an effluent, the effluent comprising a fluoride species, and wherein the reactant is selected from a group consisting of a base of calcium, sodium, potassium, lithium, magnesium, aluminum, silicon, and combinations thereof; treating the effluent in a treatment zone to provide a treated effluent, wherein the treatment zone comprises at least one of a dry sorbent injection zone; a wet scrubber zone; a carbon bed; an ion exchange zone; or any combination thereof. An embodiment of the invention is one, any or all of prior embodiments in this paragraph up through the first embodiment in this paragraph further comprising cooling, in a thermal reduction zone, the effluent before treating the effluent in the treatment zone. An embodiment of the invention is one, any or all of prior embodiments in this paragraph up through the first embodiment in this paragraph, wherein the treatment zone comprises the dry sorbent injection zone and wherein the process further comprises mixing an adsorbent with the effluent to provide the treated effluent, and wherein the adsorbent comprises sodium, calcium, potassium, magnesium, aluminum, silicon or any combination thereof in a solution or mixture. An embodiment of the invention is one, any or all of prior embodiments in this paragraph up through the first embodiment in this paragraph, wherein the dry sorbent injection zone the adsorbent comprises a mixture of a fresh adsorbent and a recycled adsorbent. An embodiment of the invention is one, any or all of prior embodiments in this paragraph up through the first embodiment in this paragraph, wherein the process further comprises quenching the treated effluent. An embodiment of the invention is one, any or all of prior embodiments in this paragraph up through the first embodiment in this paragraph, wherein the dry sorbent injection zone comprises a filtration zone configured to separate the treated effluent and provide a residue and a vent gas. An embodiment of the invention is one, any or all of prior embodiments in this paragraph up through the first embodiment in this paragraph, further comprising recycling the residue to the dry sorbent injection zone. An embodiment of the invention is one, any or all of prior embodiments in this paragraph up through the first embodiment in this paragraph, wherein the treatment zone comprises the wet scrubber zone, and wherein the process further comprises mixing an aqueous caustic stream with the effluent to provide the treated effluent. An embodiment of the invention is one, any or all of prior embodiments in this paragraph up through the first embodiment in this paragraph, wherein the aqueous caustic stream comprises sodium, calcium, potassium, magnesium, or any combination thereof. An embodiment of the invention is one, any or all of prior embodiments in this paragraph up through the first embodiment in this paragraph, further comprising separating the treated effluent into a liquid and a vent gas. An embodiment of the invention is one, any or all of prior embodiments in this paragraph up through the first embodiment in this paragraph, wherein the liquid comprises particulates. An embodiment of the invention is one, any or all of prior embodiments in this paragraph up through the first embodiment in this paragraph, wherein the treatment zone comprises the carbon bed, the ion exchange zone, or both, and wherein the process further comprises passing the liquid to the carbon bed or the ion exchange zone. An embodiment of the invention is one, any or all of prior embodiments in this paragraph up through the first embodiment in this paragraph, wherein the treatment zone comprises the carbon bed, and wherein the process further comprises passing the vent gas to the carbon bed. An embodiment of the invention is one, any or all of prior embodiments in this paragraph up through the first embodiment in this paragraph, wherein the treatment zone comprises the carbon bed, the ion exchange zone, or both, and further comprises a sensor configured to provide a measurement, and wherein the carbon bed or the ion exchange zone receive a liquid portion of the effluent, and the process further comprising determining a fluorine concentration in the liquid portion of the effluent from the measurement. An embodiment of the invention is one, any or all of prior embodiments in this paragraph up through the first embodiment in this paragraph, further comprising monitoring the fluorine concentration in the liquid portion of the effluent. An embodiment of the invention is one, any or all of prior embodiments in this paragraph up through the first embodiment in this paragraph, further comprising adjusting a process condition when the fluorine concentration is outside of a predetermined range. An embodiment of the invention is one, any or all of prior embodiments in this paragraph up through the first embodiment in this paragraph, wherein the heated PFAS has a temperature between 400° C. to 925° C. when introduced into the vessel. An embodiment of the invention is one, any or all of prior embodiments in this paragraph up through the first embodiment in this paragraph, wherein the PFAS is heated in an absence of the reactant. An embodiment of the invention is one, any or all of prior embodiments in this paragraph up through the first embodiment in this paragraph, wherein the treatment zone provides a liquid stream, and wherein the process includes recycling the liquid stream to the vessel. An embodiment of the invention is one, any or all of prior embodiments in this paragraph up through the first embodiment in this paragraph, wherein the treatment zone provides a liquid stream, and wherein the process includes quenching the effluent with the liquid stream.

A second embodiment of the invention is an apparatus for converting poly- and perfluoroalkyl substances (PFAS), the apparatus comprising a heater configured to heat a stream comprising PFAS to a temperature between 400° C. to 925° C. to provide a heated PFAS; a vessel comprising a reactant and configured to receive the heated PFAS and provide an effluent, wherein the reactant is configured to convert the PFAS into a fluoride of calcium, sodium, potassium, lithium, magnesium, aluminum, wherein the reactant is selected from a group consisting of a base of calcium, sodium, potassium, lithium, magnesium, aluminum, silicon, and combinations thereof, a treatment zone configured to receive the effluent and provide a treated effluent, wherein the treatment zone comprises at least one of a dry sorbent injection zone; a wet scrubber zone; a carbon bed; an ion exchange zone; or any combination thereof. An embodiment of the invention is one, any or all of prior embodiments in this paragraph up through the second embodiment in this paragraph, further comprising a sensor configured to provide a measurement relating to the effluent, the treated effluent, or portions thereof, and wherein the measurement relates to a fluorine concentration in the effluent, the treated effluent, or portions thereof. An embodiment of the invention is one, any or all of prior embodiments in this paragraph up through the second embodiment in this paragraph, further comprising a thermal reduction zone disposed between the vessel and the treatment zone.

Without further elaboration, it is believed that using the preceding description that one skilled in the art can utilize the present invention to its fullest extent and easily ascertain the essential characteristics of this invention, without departing from the spirit and scope thereof to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A process for converting poly- and perfluoroalkyl substances (PFAS), the process comprising:
heating PFAS to provide a heated PFAS;
introducing the heated PFAS to a vessel containing a reactant and being operated under conditions to convert the PFAS and provide an effluent, the effluent comprising a fluoride species, and wherein the reactant is selected from a group consisting of: a base of calcium, sodium, potassium, lithium, magnesium, aluminum, silicon, and combinations thereof;
treating the effluent in a treatment zone to provide a treated effluent, wherein the treatment zone comprises at least one of:
a dry sorbent injection zone;
a wet scrubber zone;
a carbon bed;
an ion exchange zone;
or any combination thereof.

2. The process of claim 1 further comprising:
cooling, in a thermal reduction zone, the effluent before treating the effluent in the treatment zone.

3. The process of claim 1, wherein the treatment zone comprises the dry sorbent injection zone and wherein the process further comprises:
mixing an adsorbent with the effluent to provide the treated effluent, and wherein the adsorbent comprises sodium, calcium, potassium, magnesium, aluminum, silicon or any combination thereof in a solution or mixture.

4. The process of claim 3, wherein the dry sorbent injection zone the adsorbent comprises a mixture of a fresh adsorbent and a recycled adsorbent.

5. The process of claim 3, wherein the process further comprises:
quenching the treated effluent.

6. The process of claim 3, wherein the dry sorbent injection zone comprises a filtration zone configured to separate the treated effluent and provide a residue and a vent gas.

7. The process of claim 6, further comprising:
recycling the residue to the dry sorbent injection zone.

8. The process of claim 1, wherein the treatment zone comprises the wet scrubber zone, and wherein the process further comprises:
mixing an aqueous caustic stream with the effluent to provide the treated effluent.

9. The process of claim 8, wherein the aqueous caustic stream comprises sodium, calcium, potassium, magnesium, or any combination thereof.

10. The process of claim 8, further comprising:
separating the treated effluent into a liquid and a vent gas.

11. The process of claim 10, wherein the liquid comprises particulates.

12. The process of claim 10, wherein the treatment zone comprises the carbon bed, the ion exchange zone, or both, and wherein the process further comprises:
passing the liquid to the carbon bed or the ion exchange zone.

13. The process of claim 10, wherein the treatment zone comprises the carbon bed, and wherein the process further comprises:
passing the vent gas to the carbon bed.

14. The process of claim 1, wherein the treatment zone comprises the carbon bed, the ion exchange zone, or both, and further comprises a sensor configured to provide a measurement, and wherein the carbon bed or the ion exchange zone receive a liquid portion of the effluent, and the process further comprising:
determining a fluorine concentration in the liquid portion of the effluent from the measurement.

15. The process of claim 14, further comprising:
monitoring the fluorine concentration in the liquid portion of the effluent.

16. The process of claim 15, further comprising:
adjusting a process condition when the fluorine concentration is outside of a predetermined range.

17. The process of claim 1, wherein the heated PFAS has a temperature between 400° C. to 925° C. when introduced into the vessel.

18. The process of claim 1, wherein the PFAS is heated in an absence of the reactant.

19. The process of claim 1, wherein the treatment zone provides a liquid stream, and wherein the process includes:
recycling the liquid stream to the vessel.

20. The process of claim 1, wherein the treatment zone provides a liquid stream, and wherein the process includes:
quenching the effluent with the liquid stream.
